(19) United States
(12) Patent Application Publication
(10) Pub. No.: US 2025/0228401 A1
(43) Pub. Date: Jul. 17, 2025

(54) GRINDING MACHINE

(71) Applicant: DANPING LIU, Shenzhen City (CN)

(72) Inventor: DANPING LIU, Shenzhen City (CN)

(21) Appl. No.: 19/023,242

(22) Filed: Jan. 15, 2025

(30) Foreign Application Priority Data
Jan. 15, 2024 (CN) 202420093618.6

(51) Int. Cl. A47J 42/36; A47J 42/40; A47J 42/46; A47J 42/50

(52) U.S. Cl. CPC A47J 42/36; A47J 42/40; A47J 42/46; A47J 42/50

(57) ABSTRACT

A grinding machine provided in the present invention, includes a base, a grinding assembly arranged in the base, and a driving unit for driving the grinding assembly. The grinding core can rotate and fit in the grinding bushing. The grinding core is movable upwards and downwards along a shaft under a corporation of a spring and balls; a distance of the gap between the grinding core and the grinding bushing is adjustable according to a movement of the grinding core, adjusting grind sizes; an adjustment knob is manually rotatable around and movable upwards and downwards along the shaft, which moves the balls out of or into hemispherical cavities on a top side of the adjustment knob, prompting the grinding core to move upwards under a force applied by the balls or downwards under a force applied by the compressible spring.

### CROSS REFERENCE TO RELATED APPLICATIONS

The present invention is 35 U.S.C. § 119 benefit of earlier filing dates; rights of priority of Chinese Applications No. 202420093618. 6 filed on Jan. 15, 2024, the disclosure of which is incorporated by reference herein.

### BACKGROUND OF THE INVENTION

### Field of the Invention

The present invention relates to the field of portable electronic appliance, and more particularly, to a powered grinding machine for coffee or food.

### Description of Related Art

With the improvement of people's living standards, people have higher and higher requirements for the quality and taste of coffee they drink. For a good taste of coffee, people like to grind coffee beans by themselves to make coffee. The grind size and uniformity of the ground powder are important to the taste of the coffee. During use, coffee beans are fed into the grinding chamber of the grinding machine. After grinding, the coffee powder falls out from the powder outlet. However, most existing coffee grinders have a single grinding mode and cannot adjust the particle size and uniformity of the ground coffee powder, such as coarse grinding and fine grinding, which cannot meet the different tastes for users.

### SUMMARY OF THE INVENTION

An object of the present invention is to is to provide a grinding machine to solve the problem that existing grinding machines cannot adjust particle sizes of the ground powder.

A grinding machine provided by the present invention, comprises: a base with a shaft hole and a cavity therein; a grinding assembly, comprising: a grinding bushing, installed in the cavity of the base; and a grinding core, rotatably fitted in the grinding bushing with a gap therebetween for grinding beans into powder; a driving unit for driving the grinding assembly; a shaft, coupled to the driving unit, rotatably passing through the shaft hole of the base and connected to the grinding core; a compressible spring in the cavity of the base, pressing against a top side of the grinding core; an adjustment knob, threaded engagement with the shaft, and pressing against a bottom side of the grinding core by means of balls, wherein a top side of the adjustment knob forms a plurality of hemispherical cavities, and each hemispherical cavity is used to receive one ball; a bean hopper, detachably connected to a top side of the base and in communication with the shaft hole and the cavity; and a powder bin, detachably connected to a bottom side of the base and in communication with the cavity. The driving unit drives the shaft to rotate the grinding core in the grinding bushing to grind bean; the grinding core is movable upwards and downwards along the shaft under a corporation of the spring and the balls; a distance of the gap between the grinding core and the grinding bushing is adjustable according to a movement of the grinding core, adjusting grind sizes; the adjustment knob is manually rotatable around and movable upwards and downwards along the shaft, which moves the balls out of or into the hemispherical cavities, prompting the grinding core to move upwards under a force applied by the balls or downwards under a force applied by the compressible spring.

In some embodiments, a connecting member is provided between the bottom side of the grinding core and the top side of the adjustment knob, and is connected to the shaft in an axial movement; the shaft rotates the connecting member and the grinding core; the balls apply the force to the grinding core through the connecting member.

In some embodiments, a bottom side of the connecting member is provided with a plurality of protruding pillars extending downwards, each of the balls are placed between adjacent protruding pillars.

In some embodiments, the grinding core defines a shaft hole, the connecting member defines a shaft hole, the adjustment knob defines a shaft hole with inner threads; the shaft passes through the shaft holes of the grinding core, rotates the grinding core, the grinding core is movable along the shaft; the shaft passes through the shaft holes of the connecting member, rotates the connecting member, the connecting member is movable along the shaft; a lower end of the shaft with threads passes through the shaft holes of the adjustment knob, rotates the adjustment knob, and the adjustment knob is movable along the shaft.

In some embodiments, the base comprises an upper housing and a lower housing that are detachably connected; each of the upper housing and the lower housing is shaped as a hollow cylinder; a first support frame is formed at a top side of the upper housing, the first support frame comprises a circular wall defining a first shaft hole for the shaft to pass through; a second support frame is formed at a top side of the lower housing and is located below the first support frame, and the second support frame define a second shaft hole for the shaft to pass through.

The advantages of the present invention are:

In the grinding machine provided by the present invention, a connecting member is provided through the grinding core, and a ball assembly is connected between the adjustment knob and the fitting. The knob adjustment knob rotates out through the balls of the ball assembly to promote the fitting. Drive the grinding core to move up and down to adjust the grinding core. The gap between the grinding bushing and the grinding bushing adjusts the particle size of the ground powder, which has high grinding efficiency and meets the user's requirements for the size of the coffee powder particles; thereby achieving a convenient multi-position gap between the grinding core and the grinding bushing. Adjust to achieve precise grinding of coffee powder of different particle sizes. When the adjustment knob is rotated, each ball spins out from the hemispheric cavity at the top of the corresponding adjustment knob when the adjustment knob is turned up. When it continues to rotate, each ball falls into the next hemispheric cavity of the adjustment knob because of the elasticity. The parts are pressed against the grinding core and then against the transmission parts. Then it is pressed to the ball assembly. Due to the effect of pressure, the ball will have a good feel when it spins out of the hemispheric cavity and then falls into the next hemisphere cavity, and the positioning is very clear. When the ball falls into the hemispheric cavity, the crisp click sound is a great experience. In addition, because the compressible spring has greater pressure to press the ball, it can ensure that the adjustment knob will not slip when it is positioned at the required position.

### BRIEF DESCRIPTION OF DRAWINGS

FIG. 1 is an exploded view of a grinding machine in accordance with an embodiment of the present invention;

FIGS. 2-3 are cross-sectional views of the grinding machine of FIG. 1;

FIG. 4 illustrates structures inside a base of the grinding machine of FIG. 1;

FIG. 5 is an exploded view of a grinding assembly of the grinding machine of FIG. 1;

FIG. 6 is an exploded view of a shaft of the grinding machine of FIG. 1;

FIG. 7 is an exploded view of an adjustment knob of the grinding machine of FIG. 1;

FIG. 8 is a perspective view of a ball assembly of the grinding machine of FIG. 1;

FIG. 9 is a perspective view of a connecting member of the grinding machine of FIG. 1; and

FIG. 10 is a perspective view of a lower housing of the grinding machine of FIG. 1.

### DETAILED DESCRIPTION OF THE INVENTION

Certain exemplary embodiments will now be described to provide an overall understanding of the principles of the structure, function, manufacture, and use of the devices and methods disclosed herein. One or more examples of these embodiments are illustrated in the accompanying drawings. Those of ordinary skill in the art will understand that the devices and methods specifically described herein and illustrated in the accompanying drawings are non-limiting exemplary embodiments. The features illustrated or described in connection with one exemplary embodiment may be combined with the features of other embodiments. Such modifications and variations are intended to be included within the scope of the present invention.

Certain terminology is used in the following description for convenience only and is not limiting. The words “a”, “an” and “one”, as used in the claims and in the corresponding portions of the specification, are defined as including one or more of the referenced items unless specifically stated otherwise. This terminology includes the words above specifically mentioned, derivatives thereof, and words of similar import. The phrase “at least one” followed by a list of two or more items, such as “A, B, or C,” means any individual one of A, B or C as well as any combination thereof.

Although the terms first, second, etc. may be used herein to describe various elements, components, regions, layers and/or sections, these elements, components, regions, layers and/or sections shall not be referred to as restricted by these terms. These terms are only used to distinguish one element, component, region, layer or section from another element, component, region, layer or section. Terms such as “first,” “second,” and other numerical terms when used herein do not imply a sequence or order unless clearly indicated by the context.

It will be further appreciated that, for convenience and clarity, spatial terms such as “vertical,” “horizontal,” “up”, “down”, “internal”, “external”, “inside”, “outside”, “below”, “beneath”, “under”, “on”, “top”, “bottom”, “front”, “rear”, “left”, “right” and etc., may be used herein with respect to the drawings. However, the device is used in many orientations and positions, and these terms are not intended to be limiting and/or absolute. For example, if the device in the figures is turned over, elements described as “below” other elements or features would then be oriented “above” the other elements or features. Thus, the example term “below” may include an orientation of above and below. The device may be otherwise oriented (rotated 90 degrees or at other orientations) and the orientation herein should be interpreted accordingly.

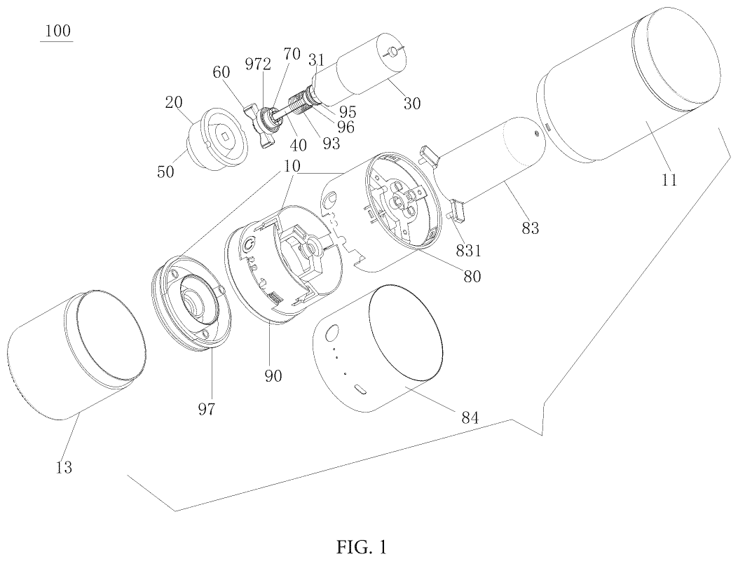

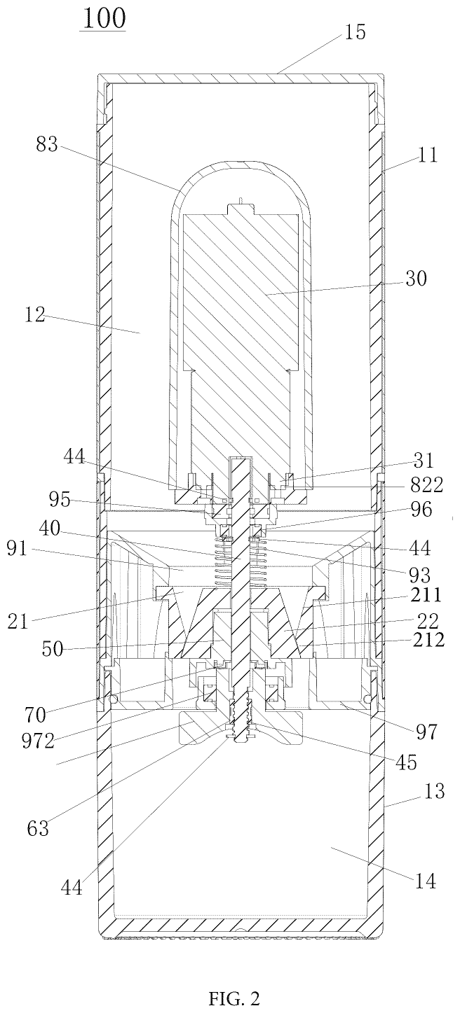

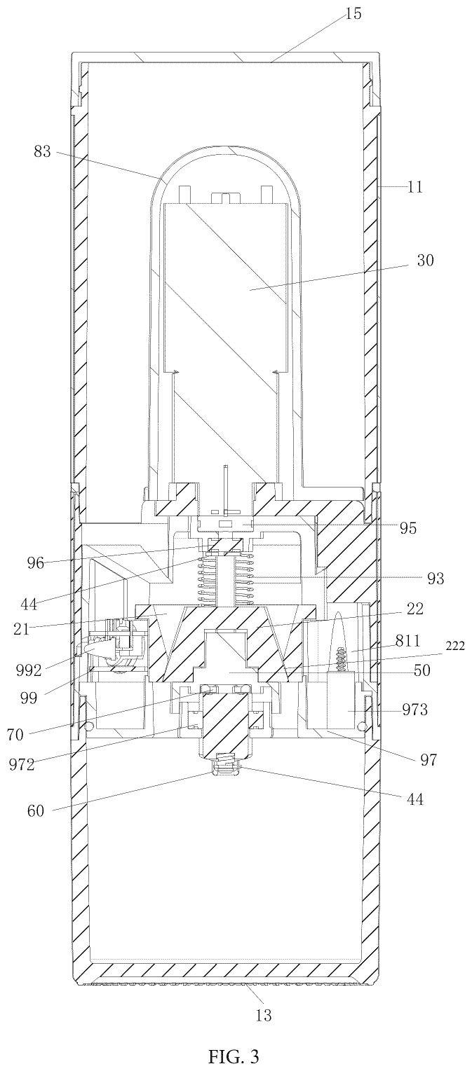

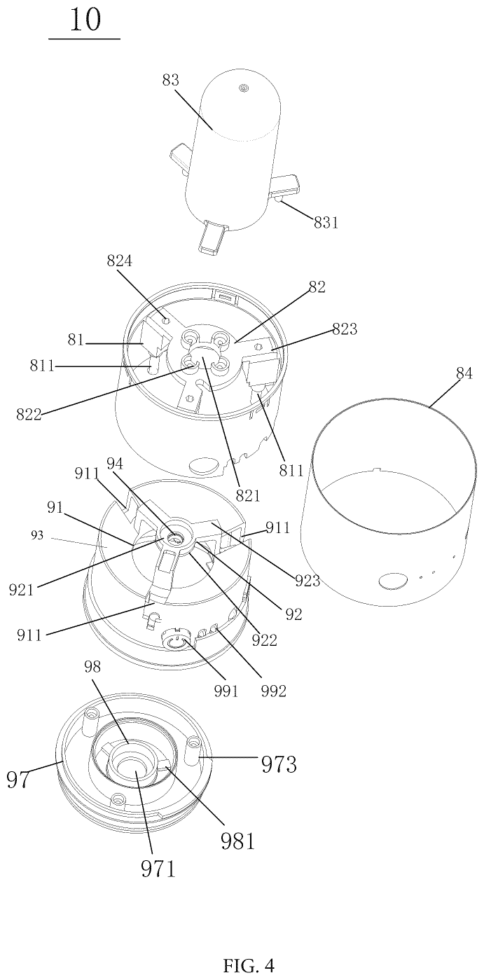

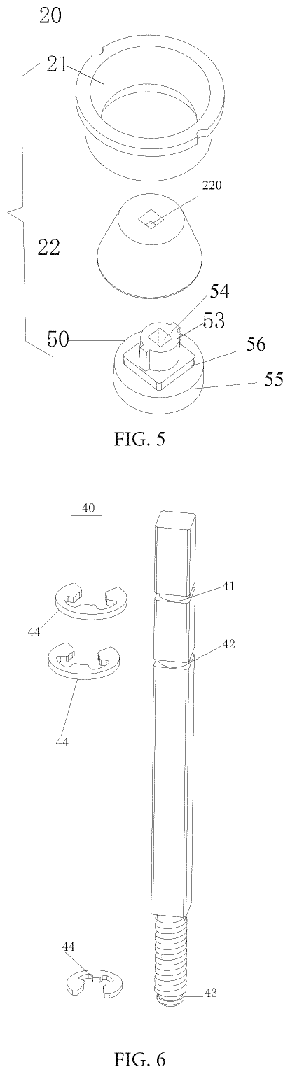

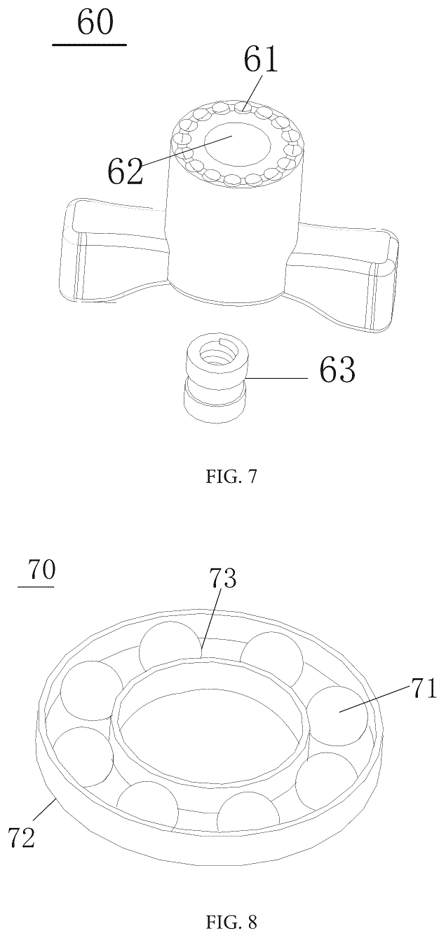

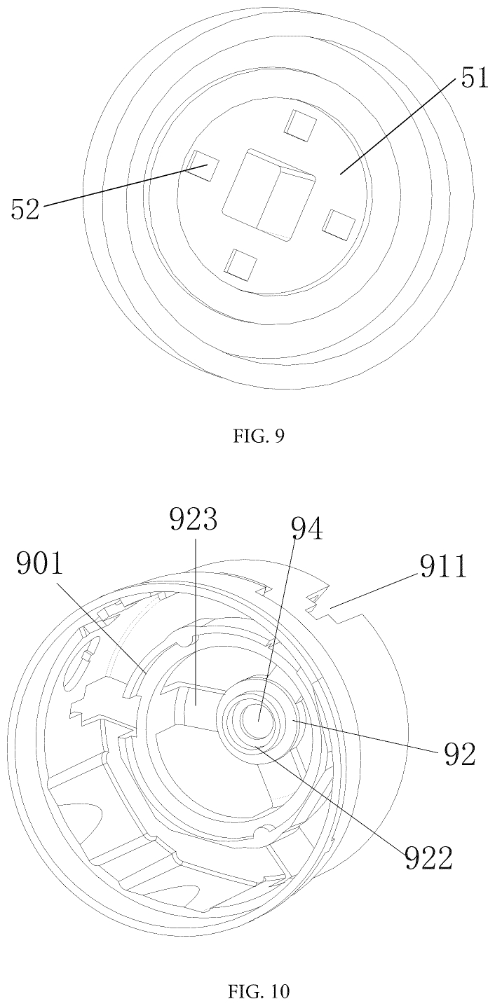

Referring to FIGS. 1-10, a grinding machine 100 of the present invention includes a base 10, a bean hopper 11, a powder bin 13, a grinding assembly 20, a driving unit 30 for driving the grinding assembly 20 to grind beans into powder, a shaft 40, a connecting member 50, an adjustment knob 60, and a ball assembly 70. The bean hopper 11 and the powder bin 13 are detachably and longitudinally (axially) connected to opposite sides (top side and bottom side) of the base 10. The base 10 axially (longitudinally) defines a cavity and a shaft hole which are communicated to each other and are communicated with the bean hopper 11 and the powder bin 13. The grinding assembly 20 is installed in the cavity of the base 10 and comprises a grinding core 22 and a grinding bushing 21. The grinding core 22 is fitted in the grinding bushing 21. The grinding core 22 and the grinding bushing 21 are spaced with a gap therebetween and are relatively rotatable to grind the beans in the gap. The beans fall from the bean hopper 11 to the grinding assembly 20, are ground into powder in the gap between the grinding core 22 and the grinding bushing 21, and the powder falls from the gap into the powder bin 13. The grinding assembly 20 is connected to the shaft 40. One end of the shaft 40 is coupled to driving unit 30 to rotate the grinding core 22 or the grinding bushing 21. The driving unit 30 is installed on the top side of the base 10 and extends in the bean hopper 11. The connecting member 50 and the adjustment knob 60 are connected to the shaft 40. The connecting member 50 and the adjustment knob 60 are connected to each other through the ball assembly 70. A compressible spring 93 is provided in the cavity of the base 10 and presses downwards against a top side of the grinding core 22, the connecting member 50 is engaged with a bottom side of the grinding core 22, the grinding core 22 can move upwards and downwards along the shaft 40 under the cooperation of the connecting member 50 and the compressible spring 93; thereby, a distance of the gap between the grinding core 22 and the grinding bushing 21 is adjustable, accordingly, a grind size is adjustable. The adjustment knob 60 is threadedly engaged with the shaft 40 and can be manually rotated up or down along the shaft 40, which brings the connecting member 50 to push or release the grinding core 22 by means of the balls 71 of the ball assembly 70.

In one embodiment, the grinding core 22 axially defines a shaft hole 220 for connecting the shaft 40. The top end of the shaft 40 is coupled to the driving unit 30 and is rotated by the driving unit 30. Generally, the driving unit 30 is a motor (also labeled as 30), which is mounted to the top side of the base 10 by means a motor housing 83. The shaft 40 is coupled to an output shaft of the motor 30, rotatably passes through the shaft hole in the base 10, and is fitted in the shaft hole 220 of the grinding core 22 to rotate the grinding core 22 synchronously. The connecting member 50 axially defines a shaft hole 54, and the shaft 40 passes through the shaft hole 54 of the connecting member 50 below the grinding assembly 20 and rotates the connecting member 50 synchronously. The adjustment knob 60 axially defines a shaft hole 62, and the shaft 40 passes through the shaft hole 62 of the adjustment knob 60 following the connecting member 50 and rotates the adjustment knob 60 synchronously.

The connecting member 50 is connected to the shaft 40 and is engaged with the grinding core 22 to further keep the grinding core 22 rotating together with the shaft 40. The adjustment knob 60 is connected to the end of the shaft 40 and is used to drive the grinding core 22 to move up and down along the shaft 40 to adjust the position of the grinding core 22 along the shaft 40, so that a distance of the gap between the grinding bushing 21 and the grinding core 22 is adjusted to adjust the grind size.

In one embodiment, the grinding assembly 20 includes the grinding bushing 21 and grinding core 22. The grinding core 22 is rotatably fitted in the grinding bushing 21. The walls of grinding core 22 and the grinding bushing 21 which are used to crush the beans are spaced with a gap distance adjustable to achieve different grind size. The grinding bushing 21 is hollow cylinder with both open ends and a space therein, forms an inclined annular wall 211 on the upper inner sidewall by means of decreasing inner diameters of the hollow cylinder from top to bottom to facilitate the beans rolling down from top to bottom, and forms a reverse inclined annular wall 212 on the lower inner sidewall by means of increasing inner diameters of the hollow cylinder. The inclined annular wall 211 and the reverse inclined annular wall 212 are connected. The grinding core 22 has a shape of a cone or a frustum of a cone, but not limited to these shapes. The reverse inclined annular wall 212 of the grinding bushing 21 and the lower side wall 222 of the grinding core 22 are adapted to each other and grind the beans falling in the gap between the reverse inclined annular wall 212 and the lower side wall 222. The space is formed in upper part of the grinding assembly 20 and located in the grinding bushing 21 and out the grinding core 22 for receiving the beans from the bean hopper 11. The grinding core 22 axially defines the shaft hole 220, the hole 220 has a shape adapted to the shaft 40, for example, the hole 220 has a cross-sectional shape of a polygon such as a quadrilateral, therefore, the shaft 40 is fitted in the shaft hole 220 of the grinding core 22 and rotates the grinding core 22 together, while the grinding core 22 can be driven to move up or down along the shaft 40 to adjust its heights. The grinding core 22 is hollow inside to form a fitting groove 23 that extend to the bottom side of the grinding core 22. The shaft hole 220 extends from the top side of the grinding core 22 and connects with the fitting groove 23. The fitting groove 23 has a contour adapted to the connecting member 50. For example, the fitting groove 23 includes a bottom groove (such as a polygonal or irregular groove) in the bottom side of the grinding core 22, and a cylindrical groove inside the grinding core 22. The bottom groove is connected with the cylindrical groove to form a stepped groove 23. There are guide grooves longitudinally defined in the inner sidewall of the cylindrical groove.

The connecting member 50 is inserted in the fitting groove 23 and is movable up and down in the fitting groove 23, therefore, the connecting member 50 can push the grinding core 22 to move upward; or can leave a space for the grinding core 22 to move downward, where the grinding core 22 move downwards under a force of the spring 93. The connecting member 50 has a shape adapted to the fitting groove 23 in the grinding core 22, and axially defines a shaft hole 54 for connecting the shaft 40. In an embodiment, the connecting member 50 has an annular bottom 55, a block (such as a polygonal or irregular block) 56 on a top side of the annular bottom 55 and corresponding to the bottom groove in the grinding core 22, and a guide column 53 extending upwards from the top side of the block 56 and corresponding to the cylindrical groove in the grinding core 22. The guide column 53 laterally forms guide ribs which can slide in the guide grooves in the grinding core 22. The annular bottom 55 includes a top wall and an annular sidewall to form a cavity 51 therein, several protruding pillars 52 extend from the top wall downwards in the cavity 51 for moving the balls 71 of the ball assembly 70 and limiting the positions of the balls 71.

The compressible spring 93 is provide between an edge of the central shaft hole in the base 10 and the top side of the grinding core 22, and is sleeve out the shaft 40. The grinding core 22 is pushed upwards by the connecting member 50 or pushed downwards by the spring 93, and is positioned by means the adjustment knob 60 after adjusting the position of the grinding core 22.

The adjustment knob 60 is connected to the lower end of the shaft 40 and is located below the connecting member 50. A threaded engagement is formed between the adjustment knob 60 and the lower end of the shaft 40, therefore, manually rotate the adjustment knob 60 and it can move upwards or downwards along the shaft 40, and can also be fixed on the shaft 40 by means of thread engagement. As an example, the shaft 40 forms a threaded end, the adjustment knob 60 has a hollow shaft 6 which axially defines a shaft hole 62. There is an internal thread nut 63 tightly fitted in or integrated with the shaft hole 62. The threaded end of the shaft 40 is inserted in the shaft hole 62 and is threadedly engaged with the internal thread nut 63 so that the adjustment knob 60 can be rotated to move up and down or be locked through the thread engagement. A plurality of hemispheric cavities 61 are formed along an annular top side of the hollow shaft 6 for receiving balls 71.

A ball assembly 70 is provided between the adjustment knob 60 and the connecting member 50. The top side of the adjustment knob 60 is provided with the plurality of hemispherical cavities 61 evenly spaced. Each ball 71 of the ball assembly 70 is adapted to each hemispheric cavity 61. When the adjustment knob 6 is turned up, each ball 71 of the ball assembly 70 spins out from the hemispheric cavity 61 at the top side of the adjustment knob 60, therefore, the connecting member 50 is pushed upwards to take the grinding core 22 moving upwards. When continues to rotate the adjustment knob 6, each ball 71 falls into the next hemispheric cavity 61, and the spring 93 can press the grinding core 22 to move downwards. By turning the adjustment knob 60 up and down, the balls 71 move out of the hemispheric cavities 61 or enter the hemispheric cavities 61, which can prompt the connecting member 50 to drive the grinding core 22 to move up and down as the knob 60 rotates to adjust the gap between the grinding core 22 and the grinding bushing 21 to adjust the grind size, thereby achieving precise grinding of coffee powder with different grind sizes.

In the embodiment of the present invention, the ball assembly 70 includes a ball seat 72 and a plurality of balls 71. The ball seat 72 is an annular groove and defines a plurality of circular holes 73 at equal intervals in its bottom side. The circular hole 73 is adapted to the ball 71 so that a part of the ball 71 can pass through the circular hole 73 to enter the hemispheric cavity 61. The ball 71 can be movably embedded in the circular hole 73. The ball seat 72 is located in the annular bottom 55 of the connecting member 50, and the shaft 40 passes through the center of the ball seat 72. The balls 71 are placed in ball seat 72, and each ball 71 is located between protruding pillars 52. Alternatively, the ball seat 72 is not necessary, the balls 71 are supported and limited by the top side of the adjustment knob 60 and the protruding pillars 52.

In the embodiment of the present invention, the base 10 includes an outer housing 84, an upper housing 80, and a lower housing 90, that are in a shape of hollow cylinders sleeved together. The inner wall of the upper housing 80 is provided with a plurality of positioning blocks 81. The lower housing 90 is provided with notches 911 that cooperate with the positioning blocks 81. The positioning blocks 81 are fastened to the notches 911 so that the upper housing 80 and the lower housing 90 are fixed together. The upper housing 80 is sleeved outside the lower housing 90.

A first support frame 82 is disposed at the center of the top side of the upper housing 80, and has a circular shape. The first support frame 82 is provided with a first shaft hole 821. The first support frame 82 is connected to the inner sidewall of the upper housing 80 through a plurality of (first) ribs 823. The positioning block 81 extends longitudinally downwards from the rib 823 along the inner sidewall of the upper housing 80. The first support frame 82, the positioning block 81 and the rib 823 may be integrated with the upper housing 80 or may be fixedly installed to the upper housing 80.

First positioning holes 824 are defined in the ribs 823. The motor housing 83 have first positioning posts 831, the motor housing 83 is installed on the top side of the base 10 by means of the first positioning posts 831 cooperating with the first positioning holes 824 in the ribs 823. The driving unit (motor) 30 is located in the motor housing 83. A plurality of second positioning posts 31 are provided at the bottom of the driving unit 30. A plurality of second positing holes 822 around the first shaft hole 821 is formed on the first support frame 82. The driving unit 30 is installed to the top side of the base 10 by inserting the second positioning posts 31 into the second positioning holes 822 accordingly. The shaft 40 passes through the first shaft hole 821 and is coupled to the driving unit 30.

The lower housing 90 has an annular inclined arc wall 93 with a plurality of notches 911 formed along a perimeter of the annular inclined arc wall and corresponding to the positioning blocks 81 of the upper housing 80. The annular inclined arc wall 93 forms a lower open 91 with a reduced open size relative to a top open side of the lower housing, which is advantageous for beans falling from the inclined arc wall 93 to the grinding assembly. The upper housing 80 is fastened to the lower housing 90 by means of the positioning blocks 81 inserted into the notches 911 accordingly. The lower housing 90 forms an annular groove 901 therein for connecting the grinding assembly 20. The grinding assembly 20 is fitted in the annular groove 901, where the grinding bushing 21 can be fastened to the annular groove wall. The lower housing 90 has a second support frame 92 above the annular inclined arc wall 93. The support frame 92 defines a second shaft hole 94 in center and is connected to the inclined arc wall 93 at the notch 91 by L-shaped (second) ribs 923 accordingly. The support frame 92 is located below the first support frame 82 and is located above the grinding assembly 20. The compressible spring 93 is provided between the support frame 92 and the grinding core 22 and is in a compressed state. The compressible spring 93 has two ends respectively resisting against the support frame 92 and the grinding core 22 respectively, so that the grinding bushing 21 and the grinding core 22 can be closely matched to further improve the grind accuracy. The spring 93 is sleeved on the shaft 40.

The support frame 92 is provided with, around the second shaft hole 94, a first annular groove 921 at its top surface and a second annular groove 922 at its back surface. A limiting circular seat 95 is provided in the first groove 921, and the limiting circular seat 95 is sleeved on the shaft 40. A bearing 96 is provided in the second groove 922 and is sleeved on the shaft 40. The first shaft hole 821 and the second shaft hole 94 are axially aligned to for the shaft hole of the base 10, and the shaft 40 rotatably passes through the first shaft hole 821 and the second shaft hole 94.

In the embodiment of the present invention, a detachable bottom cover 97 is provided at the bottom of the lower housing 90. The bottom cover 97 has a third support frame 98 that defines a third shaft hole 971 at its center. The shaft 40 rotatably passes through the third shaft hole 971. The support frame 98 has a plurality of (third) ribs 981 connected to the sidewall of the bottom cover 97. A (second) bearing 972 is provided around the third shaft hole 971 and is sleeved outside the shaft 40. The second bearing 972 is sleeved on the adjustment knob 60. The adjustment knob 60 is adjusted through the second bearing 972 so that the adjustment 60 can rotate relative to the bottom cover 97. A bottom end of the positioning blocks 81 of the upper housing 80 forms a column 811 with an internally threaded hole, and the bottom cover 97 is provided with columns 973 each with a through-hole corresponding to the internally threaded hole. The bottom cover 97, the lower housing 90 and the upper housing 80 are fastened by inserting a fastener into the hole of the columns 973 and the threaded hole of the column 811.

A control circuit board 99, and a button module 991 and an indicator module 992 are installed in the base 10 or in the bottom cover 97 with the buttons and indicators exposed outside the outer housing 84 or outside the bottom cover 97. Where the button module 991 has one or move button, and the indicator module 992 has one or more indicators. The button module 991, the indicator module 992, and the driving unit 30 are electrically connected to the control circuit board 99.

In the embodiment of the present invention, the shaft 40 (such as with a square shape) formed annular grooves for rotatably engaged with the base 10 or for position limitation, for instance, a first annular groove 41, a second annular groove 42 and a third annular groove 43, each with an elastic ring 44. The shaft 40 rotatably passes through the limiting circular seat 95 which is located in the first annular groove 921 formed at the top side of the support frame 92 of the lower housing 90, and is positioned by the elastic ring 44 clamping the first annular groove 41 and pressing on the limiting circular seat 95. The shaft 40 rotatably passes through the bearing 96 in the second groove 922 formed at the rear side of the support frame 92, and is positioned by the elastic ring 44 clamping the second annular groove 41 and pressing on the bearing 96. The third annular groove 4 with the elastic ring 44 is located at the threaded end of the shaft 40 for limiting the adjustment knob 60.

In the embodiment of the present invention, the adjustment knob 60 is provided with a shaft hole 62, and an internal thread nut 63 is provided in the shaft hole 62. The internal thread nut 63 can be an integral structure of the inner side wall of the shaft hole 62. Threads 45 are provided at the end of the shaft 40 and meshed to the internal thread nut 63.

In the embodiment of the present invention, the bean hopper 11 is detachably connected to the top side of the base 10, and the bean hopper 11 has a chamber 12. The bottom side of the base 10 is detachably connected with the powder bin 13, and the powder bin 13 has a chamber 14. The driving unit 30 is placed in the chamber 12. The top of the bean hopper 11 is open and is provided with a removable upper cover 15.

In some embodiments, the upper cover 15 can be moved to cover the bottom side of the base 10, and the powder bin 13 can be moved to be connected to and sleeved inside or outside bean hopper 11 for a shorter length for easy storage. The positions of the upper cover 15 and the powder bin 13 can be interchanged. The powder bin 13 is made of transparent material.

The technical features of the above embodiments can be combined arbitrarily. In order to make the description simple, all possible combinations of the technical features in the above embodiments are not described. However, as long as there is no contradiction in the combination of these technical features It is considered to be the range described in this specification.

The above examples only represent several embodiments of the present invention, and the descriptions thereof are specific and detailed, but should not be construed as a limitation on the scope of the invention patent. It should be pointed out that for those of ordinary skill in the art, without departing from the concept of the present invention, several modifications and improvements can also be made, which all belong to the protection scope of the present invention. Therefore, the protection scope of the patent of the present invention should be subject to the appended claims.

What is claimed is:

1. A grinding machine, comprising:
a base with a shaft hole and a cavity therein;
a grinding assembly, comprising:
a grinding bushing, installed in the cavity of the base; and
a grinding core, rotatably fitted in the grinding bushing with a gap therebetween for grinding beans into powder;
a driving unit for driving the grinding assembly;
a shaft, coupled to the driving unit, rotatably passing through the shaft hole of the base and connected to the grinding core;
a compressible spring in the cavity of the base, pressing against a top side of the grinding core;
an adjustment knob, threaded engagement with the shaft, and pressing against a bottom side of the grinding core by means of balls, wherein a top side of the adjustment knob forms a plurality of hemispherical cavities, and each hemispherical cavity is used to receive one ball;
a bean hopper, detachably connected to a top side of the base and in communication with the shaft hole and the cavity; and
a powder bin, detachably connected to a bottom side of the base and in communication with the cavity;
wherein the driving unit drives the shaft to rotate the grinding core in the grinding bushing to grind bean; the grinding core is movable upwards and downwards along the shaft under a corporation of the spring and the balls; a distance of the gap between the grinding core and the grinding bushing is adjustable according to a movement of the grinding core, adjusting grind sizes; the adjustment knob is manually rotatable around and movable upwards and downwards along the shaft, which moves the balls out of or into the hemispherical cavities, prompting the grinding core to move upwards under a force applied by the balls or downwards under a force applied by the compressible spring.

2. The grinding machine as claimed in claim 1, wherein a connecting member is provided between the bottom side of the grinding core and the top side of the adjustment knob, and is connected to the shaft in an axial movement; the shaft rotates the connecting member and the grinding core; the balls applies the force to the grinding core through the connecting member.

3. The grinding machine as claimed in claim 2, wherein a bottom side of the connecting member is provided with a plurality of protruding pillars extending downwards, each of the balls are placed between adjacent protruding pillars.

4. The grinding machine as claimed in claim 3, wherein the grinding core is hollow inside to form a fitting groove that extends to the bottom side of the grinding core; the connecting member is adapted to the fitting groove and is inserted in the fitting groove; the gear adjustment knob and the connecting member are connected through the balls; the gear adjustment knob is rotatable to move the balls to urge the connecting member to drive the grinding core moving up and down to adjust the distance of the gap between the grinding core and the grinding bushing, whereby the grind sizes of are adjustable.

5. The grinding machine as claimed in claim 4, wherein the bottom side of the connecting member includes a top wall and an annular sidewall to form a cavity therein; the protruding pillars extend from the top wall downwards in the cavity; the balls are held in a ball seat, the ball seat has an annular groove for holding the balls, and defines a plurality of circular holes at equal intervals along the annular groove; each of the circular holes is adapted to the ball and corresponds to the hemispheric cavity on the top side of the adjustment knob; the ball moves out of or into the hemispheric cavity through the circular hole.

6. The grinding machine as claimed in claim 5, wherein the connecting member includes a guide column extending upwards; the guide column laterally forms guide ribs; the fitting groove has a cylindrical groove adapted to the guide column; guide grooves are longitudinally defined in an inner sidewall of the cylindrical groove and are adapted to the guide ribs, each of the guide ribs is slidable in each of the guide grooves.

7. The grinding machine as claimed in claim 2, wherein the grinding core defines a shaft hole, the connecting member defines a shaft hole, the adjustment knob defines a shaft hole with inner threads; the shaft passes through the shaft holes of the grinding core, rotates the grinding core, the grinding core is movable along the shaft; the shaft passes through the shaft holes of the connecting member, rotates the connecting member, the connecting member is movable along the shaft; a lower end of the shaft with threads passes through the shaft holes of the adjustment knob, rotates the adjustment knob, and the adjustment knob is movable along the shaft.

8. The grinding machine as claimed in claim 1, wherein the base comprises an upper housing and a lower housing that are detachably connected; each of the upper housing and the lower housing is shaped as a hollow cylinder; a first support frame is formed at a top side of the upper housing, the first support frame comprises a circular wall defining a first shaft hole for the shaft to pass through; a second support frame is formed at a top side of the lower housing and is located below the first support frame, and the second support frame define a second shaft hole for the shaft to pass through.

9. The grinding machine as claimed in claim 8, wherein the upper housing is provided with one or more positioning blocks, the lower housing is provided with one or more notches; the upper housing is sleeved inside or outside of the lower housing with each of the positioning block fastened into each of the notch.

10. The grinding machine as claimed in claim 9, wherein the first support frame comprises first ribs connecting the circular wall to a sidewall of the upper housing, the one or more positioning blocks extends downwards from the first ribs respectively; the lower housing forms an inclined arc wall from the top side of the lower housing with a lower open at a reduced open size which is located above the grinding assembly, the one or more notches is formed along a periphery of the inclined arc wall; the second support frame is located above the inclined arc wall, and comprises a shaft sleeve with the second shaft hole therethrough and L-shaped ribs connecting the shaft sleeve to the inclined arc top wall, and each of L-shaped ribs is connected to the notch.

11. The grinding machine as claimed in claim 8, wherein the driving unit is a motor which is installed to the top side of the base and extends in the bean hopper; and the compressible spring is provided between the second support frame and the grinding core; and the compressible spring is sleeved on the rotating shaft.

12. The grinding machine as claimed in claim 8, wherein a bottom cover is provided at a bottom side of the lower housing; a third support frame with a third shaft hole therethrough is disposed transversely inside the bottom cover; the shaft rotatably passes through the third shaft hole; a control circuit board, a button module and indicator module are mounted in the bottom cover.

13. The grinding machine as claimed in claim 1, wherein the rotating shaft is shaped of non-circle, and is provided with a plurality of annular grooves, each of the annular groove is engaged with an elastic ring for positioning.

14. The grinding machine as claimed in claim 7, wherein an internal thread nut is provided in the shaft hole of the adjustment knob, or, the internal thread nut is an integral structure of an inner side wall of the shaft hole of the adjustment knob.

15. The grinding machine as claimed in claim 1, wherein a top end of the bean hopper is open and is provided with a removable cap; positions of the cap and the powder bin is interchanged.

16. The grinding machine as claimed in claim 15, wherein the cap is moved to cover the bottom side of the base, and the powder bin is moved to cover the top end of the bean hopper, the powder bin is sleeved inside or outside bean hopper for a shorter length for easy storage.
